(19) United States
(12) Patent Application Publication
(10) Pub. No.: US 2009/0189304 A1
(43) Pub. Date: Jul. 30, 2009

(54) Encapsulation of oils by coacervation

(76) Inventors: Thomas E. Friedmann, Hockessin, DE (US); Simon Owen Lumsdon, Wilmington, DE (US); John Henry Green, Oxford, PA (US)

Correspondence Address: Edward F. Rehberg;E. I. du Pont De Nemours and Company, Legal Patent Records Center, 4417 Lancaster Pike, Wilmington, DE, 19805, US

(21) Appl. No.: 10/592,964

(22) PCT Filed: Apr. 20, 2005
(86) PCT No.: PCT/US05/13866

§ 371 Date: Sep. 13, 2006

Related U.S. Application Data
(60) Provisional application No. 60/564,039, filed on Apr. 21, 2004.

(51) Int. Cl. B01J 13/08

(52) U.S. Cl. 264/4.1

(57) ABSTRACT

The present invention describes the encapsulation of water insoluble oils by coacervation and the subsequent reduction in oxidative degradation of these oils in microencapsulated forms. Water insoluble oils useful in the process of the invention include food oils such as PUFA, flavor oils, and agriculturally and pharmaceutically active oils.

### FIELD OF THE INVENTION

The present invention is in the field of microencapsulation of oils by coacervation.

### BACKGROUND OF THE INVENTION

Coacervation offers a wide application range for encapsulation of many types of active ingredients. These active ingredients can include, for example, PUFA (polyunsaturated fatty acid) oils, other food ingredients (flavor oils, vitamins and other hydrophobic components), agrochemical active ingredients and ingredients for health care products. A good understanding of the barrier properties of the coacervate shell and control over the thermal and mechanical stability of the shell can provide, among other things, a variety of specialized applications for this technology, including controlled release, taste masking and the ability to prevent chemical deteriation of the encapsulated oil. Many oils in the food and flavor categories have properties such as strong flavor and instability to oxidation, and thus it is often necessary to encapsulate these oils in a core-shell material to make them palatable and to provide reduced oxidative degradation. One technique that can be used to accomplish this is complex coacervation [B. K. Green; L. Schleicher, U.S. Pat. No. 2,800,457, 1957]. This is an established technique that has been used previously in a number of commercial applications [T. G. Lunt, Leatherhead Food RA Research Reports, No. 181, 1972 and R. D. Harding, Leatherhead Food RA Research Reports, No. 194, 1973]. The current invention provides an improved process, as well as products, for the microencapsulation of oils by coacervation, as well as a characterization technique to quantify the coating performance.

### SUMMARY OF THE INVENTION

The present invention describes a process for microencapsulating water insoluble oils, comprising the steps of:
(a) forming a fine emulsion comprising said water insoluble oil and a complex polysaccharide in the presence of a starch;
(b) adding to the emulsion of step (a) a protein at a temperature of about 40° C. to about 50° C.;
(c) adjusting the pH of the composition of step (b) to a pH below the isoelectric point of said protein;
(d) densifying the composition of step (c) by cooling said composition to a temperature below 40° C.; and
(e) adjusting the pH of the composition of step (d) to below about pH 10.

The invention further describes a process comprising the additional, optional, steps of
(f) adding a crosslinking agent to the composition of step (e);
(g) concentrating the microencapsulated composition; and
(h) spray drying the composition of step (g) to produce dry, microencapsulated oil particles.

The invention further relates to products made by the processes described, as well as the compositions of those products.

### BRIEF DESCRIPTION OF THE FIGURES

FIG. 1 is a graph showing the effect of pH on the normalized surface charge of particles of the invention.

FIG. 2(a) is an optical micrograph of a coacervate with a mean diameter of 14.6 μm.

FIG. 2(b) is a graph showing the particle size distribution of the coacervate particles of FIG. 2(a).

FIG. 3 is an optical micrograph of the coacervate particles that have been spray dried with gelatin.

FIG. 4 is a graph showing the effect of temperature in a VLE (vapour-liquid-equilibria) cell on the pressure drop as a function of time.

FIG. 5 is a graph showing the pressure drop as a function of propanal concentration.

FIG. 6 is a graph showing the concentration of oxygen consumed per surface area of coacervate droplets as a function of time.

FIG. 7 is a graph showing microcompression data for spray dried coacervate particles of specific diameters.

### DETAILS OF THE INVENTION

The coacervation process generally involves the formation of an oil-in-water emulsion, which is stabilized by a polysaccharide and a soluble protein. These molecules are interwoven through electrostatic interactions to form a core-shell material around the dispersed oil droplets. In previous work, the initial oil-in-water emulsion was stabilized by the soluble protein (e.g. gelatin) [V. M. McKeman, Flavour Industry, v.4, (2), 70-74, 1973]. Addition of a polysaccharide (e.g. gum arabic) to the dispersion, followed by lowering the pH below the isoelectric point of the protein, initiated the strong electrostatic interaction between the molecules. The resultant shell was hardened by cooling and further stabilized by addition of a cross-linking agent (e.g. glutaraldehyde).

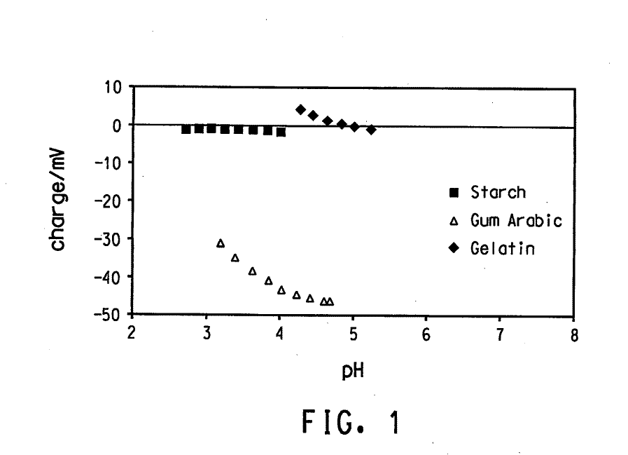

However, the application of this classical coacervation method to oil encapsulation was unsatisfactory due to poor emulsion stability in the presence of gelatin. The oil-in-water emulsion, formed, for example, by using a rotor-stator homogenizer at 40° C., was found to be more stable in the presence of the polysaccharide (gum arabic) than the soluble protein (gelatin), and was further stabilized by the addition of a waxy corn starch (high amylopectin content). Starch is commonly used as a stabilizing agent and also contributes to the oxygen barrier properties of the coating. [R. Buffo, G. Reineccius, Perfumer & Flavorist, 25 (3), 37-51, 2000]. The coacervation proceeds by adding the gelatin solution to the emulsion at 40° C. The natural pH of the dispersion containing gelatin, gum arabic, starch and PUFA oil is approximately 5.5. When the pH was lowered to 4 using 1.0 M citric acid, the charge on the gelatin molecule changed from negative to positive, which initiated an interaction with the negatively charged gum arabic, as shown in FIG. 1.

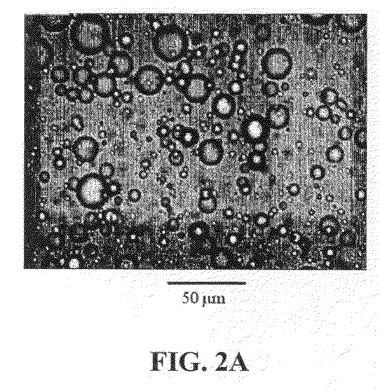

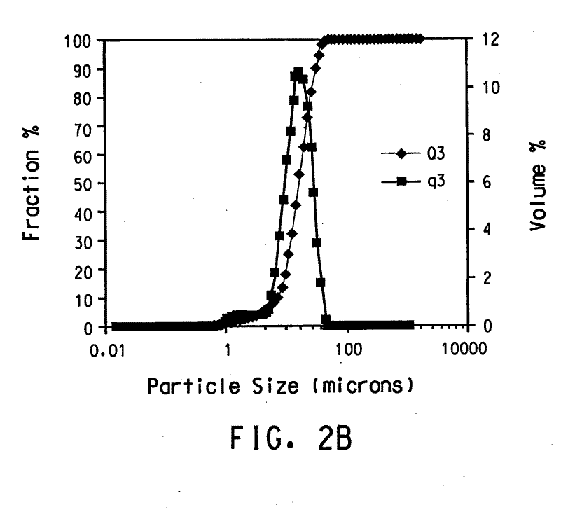

The resultant shell can be hardened by cooling to 5° C. for 45 minutes, and can be stabilized further by addition of glutaraldehyde at pH 9 (following 1.0 M NaOH addition), which binds to the amino sites on the gelatin molecule in a cross-linking reaction. The resultant coacervate contained spherical droplets of diameter between 2 and 40 μm (depending on the speed of the rotor-stator and the concentration of ingredients), which did not coalesce within the time-frame studied (at least 3 months) as shown in FIG. 2.

Literature suggests that coacervate capsules have a continuous shell, although the shell is not of uniform thickness [P. Vilstrup, ed. ‘Microencapsulation of Food Ingredients’, Leatherhead, Surrey, 2001]. Paetznick [D. J. Paetznick, G. A. Reineccius, T. L. Peppard, in Controlled Release Society 30^{th} Annual General Meeting, Glasgow, Scotland, 2003] reports that most coacervates that are commercially available show a Rugby-ball shaped morphology. This particular morphology does not use the coating material efficiently since parts of the active material are only protected by a thin layer whereas larger amounts of encapsulate material is concentrated at the tips of the Rugby-ball shaped particle. The coacervates of the present invention show a spherical shape, providing a better utilization of the encapsulate material. The mixing and dispersion conditions during the coacervation process are believed to influence the final encapsulate shape. See FIG. 2.

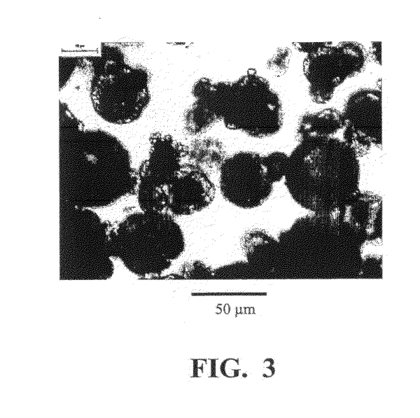

If desired, the final coacervate can be spray dried to remove excess water, resulting in particles of diameter between about 25 and 100 μm (FIG. 3).

In the present invention, the integrity of the core-shell material was characterized further using surface oil measurements. In this experiment the coacervate was agitated thoroughly with hexane, in order to solubilize any un-encapsulated or poorly encapsulated PUFA oil. The hexane is then separated and evaporated to dryness so that any residual PUFA oil could be detected. In the majority of cases, less than 1% of the total oil in the coacervate was found to be surface oil. Thus, the microencapsulation process is found to be very efficient.

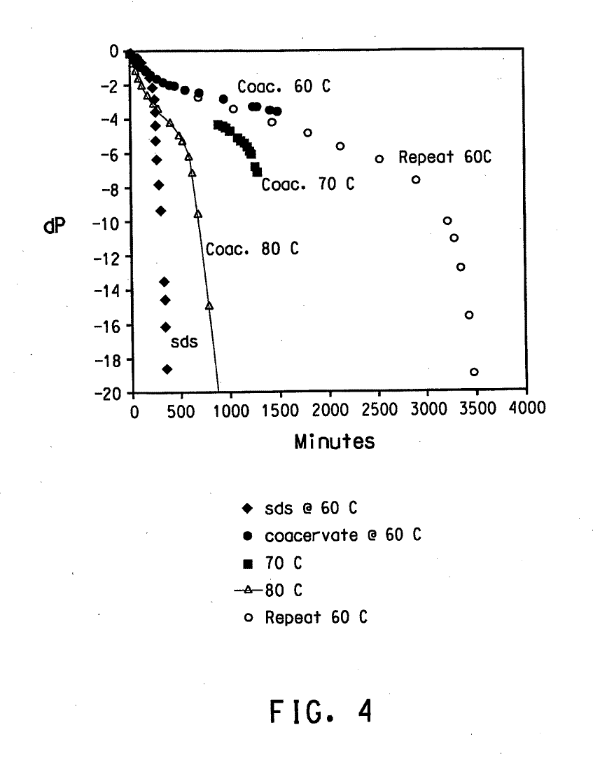

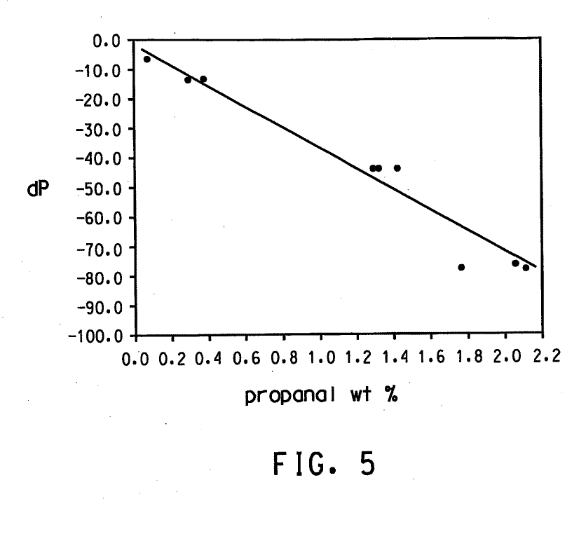

One primary purpose of the core-shell material is to protect the PUFA oil droplets from oxidation. Oxidation leads to the formation of various degradation products many of which have off tastes and odors, including propanal. A test of this aspect can be carried out in a VLE cell, as shown in C.-P. Chai Kao, M. E. Paulaitis, A. Yokozeki, Fluid Phase Equilibria, 127, 191 (1997), which enables work at elevated temperature and pressure under continuous stirring. The consumption of oxygen can be measured by recording the pressure drop as a function of time (FIG. 4), which we have shown to be in direct correlation with propanal production via GC analysis of the aqueous phase throughout the experiment (FIG. 5). It was noted that an uncoated sodium dodecyl sulphate (SDS)-stabilized PUFA emulsion degrades completely in just over 6 hours at 6° C. (FIG. 4). In contrast, a coacervate at the same temperature begins to degrade after 2 days. For an identical coacervate formulation, the rate of degradation is almost doubled by increasing the temperature by 1° C. to 70° C., and again to 80° C. Even at 80° C. however, the coacervate is more stable than the SDS emulsion at 60° C.

In FIG. 5 the pressure drop is plotted as a function of the propanal concentration for the SDS stabilized PUFA emulsion. The linear correlation confirms that PUFA degradation is directly proportional to oxygen consumption.

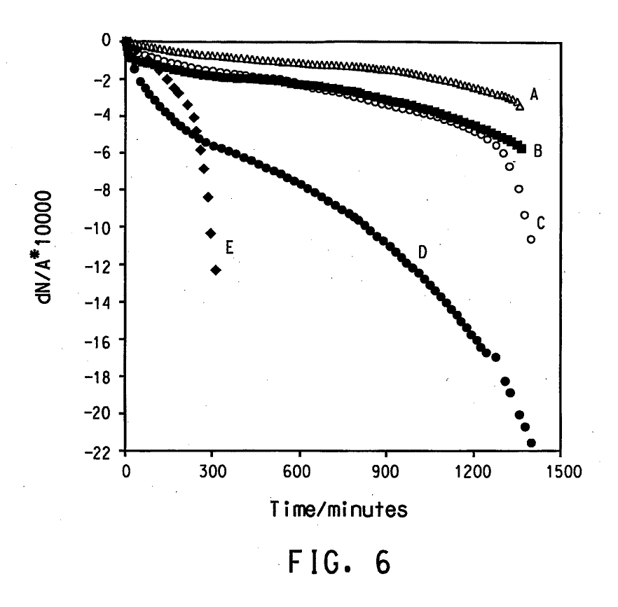

The flux of molecules across the coating layer can be determined by plotting the moles of oxygen consumed per surface area of the droplets as a function of time (FIG. 6). The surface area was calculated from the particle size distributions measured on the Malvem Mastersizer 2000, with Hydro 2000S presentation unit. The slope of these lines gives a direct indication of the quality of the coating.

Coacervates with a low concentration of formulation ingredients (Curve D) show a steep slope suggesting the thickness of the coating is not high enough to prevent oxidation. As the concentration of ingredients increases (Curve A), the slope levels off, confirming that coating thickness is a critical factor in oxidation stability. Curve E shows the flux across an SDS surfactant-stabilized emulsion. This provides a minimal barrier to oxidation so there is a high flux in and out of the droplet.

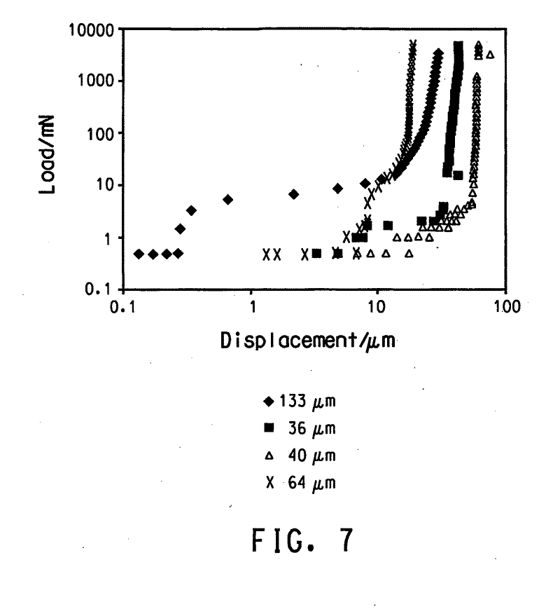

The integrity of the coating around a single spray dried particle has been tested using a Shimadzu Micro-compression unit (MCTM-500, with 500 μm tip), which measures the displacement as a function of the load applied to the particle, as shown in FIG. 7. At the end of each compression experiment the particle bursts and the fragmented shell can be seen around the free oil.

As used herein, the term “emulsion” means a stable dispersion of one liquid in a second immiscible liquid.

As used herein, the term “emulsification” refers to a process of dispersing one liquid in a second immiscible liquid. Generally, shear is required for the formation of emulsion droplets, which can be generated from a variety of dispersion devices including but not limited to microfluidizers, high-pressure homogenizers, colloid mills, rotor-stator systems, microporous membranes, ultrasound devices, and impeller blades.

As used herein, “water solubility” refers to the number of moles of solute per liter of water that can be dissolved at equilibrium temperature and pressure.

As used herein, water insoluble oils” are those oils having a solubility of generally less than about 4 weight percent in water. Non-limiting examples of such oils include: marine oils (whale oil, seal oil, fish oil, algae oil); oils of plant origin (fruit pulp oils such as olive and palm oils; seed oils such as sunflower, soy, cottonseed, rapeseed, peanut, and linseed oils); oils of microbial origin; poly-unsaturated fatty acid (PUFA) oils; flavor oils (citrus, berry, flavorings including aldehydes, acetates and the like; (R)-(+)-limonene); pharmaceuticals (including nutraceuticals) and crop protection chemicals (e.g. insecticides, herbicides and fungicides) whether as liquids or as solutions of the active ingredient in carrier oil.

As used herein, “starch” refers to a complex carbohydrate widely distributed in plant organs as storage carbohydrates. Typical raw materials for starches are corn, waxy corm, potato, cassaya, wheat, rice, and waxy rice. Starch is typically a mixture of two glucans (amylose and amylopectin), and its properties can be adjusted by physical and chemical methods to produce modified starches. The starches find use in the present invention when used as an aqueous solution with polysaccharides, to stabilize an oil-in-water emulsion.

As used herein, “polysaccharides” refers to monosaccharides bound to each other by glycosidic linkages. These are used with the starches to stabilize the oil-in-water emulsions. Non-limiting examples of polysaccharides useful in the present invention include: gum arabic, carageenans, xanthan gum, pectin, cellulose, cellulose derivatives, agar, alginates, furcellaran, gum ghafti, gum tragacanth, guaran gum, locust bean gum, tamarind flour, arabinogalactan.

As used herein, “protein” refers to any of numerous naturally occurring complex substances that consist of amino-acid residues joined by peptide bonds, and contain the elements carbon, hydrogen, nitrogen, oxygen, usually sulfur, and occasionally other elements (as phosphorus or iron), and include many essential biological compounds (as enzymes, hormones, or immunoglobulins). In the present invention, they are generally added as an aqueous solution to the oil-in-water emulsion. Non-limiting examples include gelatins, β-lactoglobulin, soy and casein.

As used herein, “microencapsulation” refers to the formation of a shell around a particle of material for the purpose of controlling the diffusion of molecules from, or into, the particle. The shell thickness is not necessarily uniform. In the present invention, the shell may be used to protect the encapsulated oil from oxygen degradation. It may also be used to control the release of flavor or crop protection active ingredient out of the particle. Generally the microencapsulated particles of the present invention are between 1 and 100 μm in diameter, depending on the shear during emulsification. Generally, higher shear provides smaller particles.

As used herein, a “cross-linking agent” is optionally employed. The agent is used to cross-link the protein molecule in the shell material by forming bonds between the carboxyl groups on the aldehyde moiety and the amine groups on the protein moiety. While many different cross-linking agents could be used, a particularly useful one for the present invention is glutaraldehyde, which is FDA approved for use in specific food applications at low concentrations (see 21 CFR 172.230).

Spray drying is optionally employed in the present invention. This involves the atomization of a liquid feedstock into a spray of droplets and contacting the droplets with hot air in a drying chamber. The sprays are generally produced by either rotary (wheel) or nozzle atomizers. Evaporation of moisture from the droplets and formation of dry particles proceeds under controlled temperature and airflow conditions. Many ingredients in the food industry are spray dried such as milk powder, instant coffee, soy protein, gelatin, flavors and vitamins. Other methods of drying include pneumatic conveying drying, vacuum freeze drying.

In the examples below, all chemicals and reagents were used as received from Aldrich Chemical Co., Milwaukee, Wis., unless otherwise specified.

“Strawberry jammy” flavor from USA Flavors, Dayton, N.J. (flavor compound comprising acetic acid, 003A422).

“Citrus” flavor from USA Flavors, Dayton, N.J. (flavor compound comprising D-limonene, methyl acetate and propionaldehyde, 48364).

PUFA—RoPUFA ‘30’ n−3 food oil, Roche.

Gelatin—Polypro 5000, Liener-Davis USA.

Gum Arabic—TIC Pretested® Pre-hydrated Gum Arabic Spray Dry FCC Powder, TICGums, Belcamp, Md.

Starch—National Starch & Chemical Co., Bridgewater, N.J.

Glutaraldehyde—EM Science, 25% in water, Gibbstown, N.J.

### EXAMPLES

### Example 1

Micro-encapsulates of mean diameter ranging between 1 and 100 μm, were prepared from formulations containing gelatin, gum arabic, starch and a cross-linking agent.

### (A) Preparation of Aqueous Solutions

A solution in distilled water containing 2-10 wt. % gum arabic and 2-10 wt % starch was prepared by magnetic agitation for 15 minutes at 40° C. A separate solution of 10-20 wt. % gelatin in distilled water was also prepared at 40° C.

### (B) Emulsification

45 g of the gum arabic/starch solution was then emulsified with 5 g of polyunsaturated fatty acid (PUFA) oil by mechanical agitation for 5 minutes at 6500-13500 rpm (Ultra-Turrax T25 Basic—IKA Werke).

### (C) Coacervation

50 g of gelatin solution was then added (sub-surface) to the magnetically agitated emulsion and the pH lowered to 4 using 1 M citric acid solution. This dispersion was then cooled to 5° C. in a water/ice-bath for 30 minutes with continuous magnetic agitation.

### (D) Cross-Linking

The sample was removed from the ice-bath and the pH raised to 9 using 1 M NaOH solution. 5 ml of the cross-linking agent was then added as a 4-8 wt. % aqueous solution, with continuous magnetic agitation.

### (E) Centrifugation

The micro-encapsulated particles were then concentrated in a centrifuge at 2000 G for 5 minutes, and the concentrated cream was then separated from the resolved aqueous phase, by skimming. The cream had an encapsulated oil content of between 35 and 55%, with less than 1% un-encapsulated oil.

The oxidation barrier performance of the micro-encapsulates was determined by measuring the consumption of oxygen and evolution of propanal at elevated temperature (70° C.) and pressure (100 psia). The consumption of oxygen was shown to be directly proportional to the evolution of propanal. The flux of oxygen through the encapsulating shell was measured by plotting the mols of oxygen consumed per surface area of the droplets as a function of time, as shown in FIG. 6.

### Example 2

Micro-encapsulates of mean diameter ranging between 1 and 100 μm, were prepared from formulations containing gelatin, gum arabic, starch and a cross-linking agent.

The protocol described in Example 1 was repeated, replacing the poly-unsaturated fatty acid (PUFA) oil with (R)-(+)-limonene, a flavor oil. This gave a creamy yellow dispersion, containing spherical droplets, with no free un-encapsulated oil. The size of the encapsulated droplets remained constant for at least 1 week.

### Example 3

Micro-encapsulates of mean diameter ranging between 1 and 100 μm, were prepared from formulations containing gelatin, gum arabic, starch and a cross-linking agent.

The protocol described in Example 1 was repeated, replacing the poly-unsaturated fatty acid (PUFA) oil with an agricultural active ingredient for example IN-KN128, (Indoxacarb available commercially) which is an insecticide, dissolved in methylated seed oil. This gave an opaque dispersion, containing spherical droplets, with no un-encapsulated oil. Again, the drop size remained constant for at least 1 week.

### Example 4

The protocol in Example 1 is repeated to form PUFA oil micro-encapsulates of mean diameter ranging between 1 and 100 μm, prepared from formulations containing P-lactoglobulin (instead of gelatin), gum arabic and starch. No cross-linking agent was used in this formulation. The continuous aqueous phase surrounding the particles was analyzed for propanal after the coacervate had been stored in an oven at 60° C. for 4 days. No propanal was detected. The gelatin coacervate also prevented the detectable evolution of propanal under the same conditions. Propanal is a recognized product of PUFA oil degradation.

### Example 5

The protocol in Example 1 was repeated to form PUFA oil micro-encapsulates of mean diameter ranging between 1 and 100 μm, prepared from formulations containing cellulose (instead of gum arabic), starch and gelatin. Minimal surface oil was detected (<0.25%) and the droplets were stable for at least 1 week.

### Examples 6 and 7

The protocol in Example 1 was repeated to form flavor oil microencapsulates of mean diameter ranging between 1 and 100 μm, prepared from formulations containing 5 wt. % flavored oil (strawberry jammy or citrus), 8 wt. % gum arabic, 8 wt. % starch and 20 wt. % gelatin. No cross-linking agent was used. The homogenization speed was 9500 rpm (Ultra-Turrax T25 Basic—IKA Werke). The encapsulates were isolated after concentrating by centrifuge at 2000 G (Beckman Coulter Allegra® 21R) and spray dried.

### Comparative Example A

The PUFA oil-in-water emulsion was stabilized using 8 mM SDS (Sodium dodecyl sulphate) in water. SDS is an anionic surfactant purchased from (Acros Chemical, NJ). The oil drops are between 1 and 100 μm in diameter, depending on the speed of emulsification. These drops have an equivalent surface area to the coacervate particles but do not provide a barrier to oxidation.

What is claimed is:

1. A process for microencapsulating water insoluble oils, comprising the steps of:
(a) forming a fine emulsion comprising said water insoluble oil and a complex polysaccharide in the presence of a starch;
(b) adding to the emulsion of step (a) a protein;
(c) adjusting the pH of the composition of step (b) to a pH below the isoelectric point of said protein;
(d) densifying the composition of step (c); and
(e) adjusting the pH of the composition of step (d) to below about pH 10.

2. The process of claim 1, wherein at step (b) the emulsion is at a temperature of about 40° C. to about 50° C.

3. The process of claim 1 wherein at step (d) densification is accomplished by cooling said composition to a temperature below about 40° C.

4. The process of claim 1, further comprising step (f) adding a cross-linking agent to the composition of step (e).

5. The process of claim 4, further comprising step (g) concentrating the microencapsulated composition of step (e) or (f).

6. The process of claim 5, further comprising step (h) spray drying the composition of step (e), (f) or (g) to produce dry, microencapsulated oil particles.

7. The process of claim 5, wherein at step (g) the composition is concentrated by centrifugation.

8. The process of claim 1, wherein the water insoluble oil is selected from the group consisting of a marine oil, a plant oil, a microbial oil, a poly-unsaturated fatty acid oil (PUFA), a flavor oil, an oil comprising an agriculturally active ingredient and an oil comprising a pharmaceutical.

9. The process of claim 1 wherein the polysaccharide is selected from the group consisting of gum Arabic, carageenans, xanthan gum, pectin, cellulose, cellulose derivatives, agar, alginates, furcellan, gum ghatti, gum tragacanth, guaran gum, locust bean gum, tamarind flour and arabinogalactan.

10. The process of claim 1 wherein the protein is selected from the group consisting of gelatin, β-lactoglobulin, soy and casein.

11. The process of claim 4 wherein the water insoluble oil is a PUFA; wherein the polysaccharide is gum arabic; wherein the protein is gelatin; and wherein the cross-linking agent is glutaraldehyde.

12. The process of claim 4 wherein the water insoluble oil is a PUFA; wherein the polysaccharide cellulose; wherein the protein is gelatin; and wherein the cross-linking agent is glutaraldehyde.

13. The process of claim 4 wherein the water insoluble oil is a PUFA; wherein the polysaccharide is gum arabic; wherein the protein is gelatin; and wherein no cross-linking agent is used.

14. The process of claim 4 wherein the water insoluble oil is a flavor oil; wherein the polysaccharide is gum arabic; wherein the protein is gelatin; and wherein the cross-linking agent is glutaraldehyde.

15. The process of claim 4 wherein the water insoluble oil is an agriculturally active ingredient; wherein the polysaccharide is gum arabic; wherein the protein is gelatin; and wherein the cross-linking agent is glutaraldehyde.

16. The process of claim 4 wherein the water insoluble oil is a pharmaceutical; wherein the polysaccharide is gum arabic; wherein the protein is gelatin; and wherein the cross-linking agent is glutaraldehyde.

17. A product made by the process of claim 1.
